(19) United States
(12) Patent Application Publication
(10) Pub. No.: US 2003/0159470 A1
(43) Pub. Date: Aug. 28, 2003

(54) Curved glass forming machine

(76) Inventor: Sung-Ho Park, Jeonrabuk-Do (KR)

Correspondence Address: CANTOR COLBURN, LLP, 55 GRIFFIN ROAD SOUTH, BLOOMFIELD, CT, 06002

(21) Appl. No.: 10/276,451

(22) PCT Filed: May 18, 2001
(86) PCT No.: PCT/KR01/00823

(30) Foreign Application Priority Data
May 18, 2000 (KR) 2000/14112U
May 16, 2001 (KR) 2001/26813

(51) Int. Cl. C03B 23/02

(52) U.S. Cl. 65/291

(57) ABSTRACT

Disclosed is an apparatus for manufacturing a bent glass sheet. The apparatus comprises a plurality of height adjusting sections which are separately configured at both sides of a body of the apparatus along a lengthwise direction of the body adjacent to an upper end of the body and each of which has a link mechanism, the link mechanism being connected with a threaded shaft which extends in a widthwise direction of the body, so as to be folded and unfolded by virtue of normal and reverse rotations of the threaded shaft; and a forming mold positioned at the upper end of the body so that the forming mold is supported by the plurality of height adjusting sections, the forming mold extending over an entire length of the body.

### TECHNICAL FIELD

The present invention relates to a curved glass forming machine, which forms a flat glass sheet into a bent glass sheet, and more particularly, the present invention relates to an apparatus for manufacturing a bent glass sheet, which enables a bent glass sheet forming work to be performed in a convenient manner while curvature adjustment is freely implemented in such a way as to allow bent glass sheets having a variety of contours to be manufactured, and in which a ceramic cloth is laminated to an upper surface of a forming mold so that, upon forming of the bent glass sheet, a mark or an air bubble is not created and thereby a fraction defective is remarkably decreased.

### BACKGROUND ART

Generally, a bent glass sheet is used for the purpose of improving an aesthetic appearance of a building and promoting space utilization in diverse industrial fields.

In manufacture of a bent glass sheet, a bearing surface of a forming mold is first curved into a desired contour. Then, after a flat glass sheet is brought onto the forming mold, heat of about 700° C. is applied to the flat glass sheet. By this, as the flat glass sheet droops to fit on the desired contour, the flat glass sheet is formed into the bent glass sheet.

However, the conventional method for manufacturing a bent glass sheet suffers from a drawback in that, when a contour of a bent glass sheet varies depending upon a use of the bent glass sheet, since a worker must prepare every time a forming mold which has a curvature to correspond to the contour of the bent glass sheet, a great deal of effort and time is required and thereby a manufacturing cost is increased.

### DISCLOSURE OF THE INVENTION

Accordingly, the present invention has been made in an effort to solve the problems occurring in the related art, and an object of the present invention is to provide an apparatus for manufacturing a bent glass sheet, which enables a bent glass sheet forming work to be performed in a convenient manner while curvature adjustment is freely implemented in such a way as to allow bent glass sheets having a variety of contours to be manufactured.

Another object of the present invention is to provide an apparatus for manufacturing a bent glass sheet, in which a ceramic cloth is laminated to an upper surface of a forming mold so that, upon forming of the bent glass sheet, a mark or an air bubble is not created and thereby a fraction defective is remarkably decreased.

In order to achieve the above objects, according to one aspect of the present invention, there is provided an apparatus for manufacturing a bent glass sheet, comprising: a plurality of height adjusting sections which are separately configured at both sides of a body of the apparatus along a lengthwise direction of the body adjacent to an upper end of the body and each of which has a link mechanism, the link mechanism being connected with a threaded shaft which extends in a widthwise direction of the body, so as to be folded and unfolded by virtue of normal and reverse rotations of the threaded shaft; and a forming mold positioned at the upper end of the body so that the forming mold is supported by the plurality of height adjusting sections, the forming mold extending over an entire length of the body.

According to another aspect of the present invention, each height adjusting section has a first operating nut and a second operating nut which are secured to two hinge bolts for the link mechanism and internally threaded in different directions from each other; and the threaded shaft which passes through the first and second operating nuts, is formed with a left-handed screw and a right-handed screw which are threadedly coupled with the first operating nut and the second operating nut, respectively.

According to another aspect of the present invention, each link mechanism is composed of a pair of front and rear link mechanism parts, and a pair of mold supporting plates are uprightly mounted to upper ends of the pair of link mechanism parts so that the mold supporting plates are orthogonal to the link mechanism parts, respectively.

According to another aspect of the present invention, the forming mold has a shape of a plate which is made of stainless steel and on an upper surface of which a ceramic cloth is laminated.

According to still another aspect of the present invention, the forming mold comprises a plurality of transverse rods each of which is laminated on a circumferential outer surface thereof with a ceramic cloth, and both ends of each transverse rod are respectively secured to connection plates which extend in the lengthwise direction of the body so that the transverse rods are supported by the height adjusting sections by the medium of the connection plates.

According to yet still another aspect of the present invention, a rolling section which has a freely rotatable roller, is provided to the height adjusting section which is located below the connection plate of the forming mold; and wherein a locking section is configured by the fact that a locking shaft is placed between the rolling section and the link mechanism in such a way as to be pushed and pulled thereby to be moved in the widthwise direction of the body, a hook is integrally formed with the locking shaft to extend in an upward direction, and an engaging projection which is to be engaged with the hook, is formed on a lower surface of the connection plate.

### BRIEF DESCRIPTION OF THE DRAWINGS

The above objects, and other features and advantages of the present invention will become more apparent after a reading of the following detailed description when taken in conjunction with the drawings, in which:

FIG. 1 is a side view illustrating an entire construction of an apparatus for manufacturing a bent glass sheet in accordance with an embodiment of the present invention;

FIG. 2 is a partial enlarged side view illustrating a structure of a height adjusting section of the apparatus for manufacturing a bent glass sheet in accordance with the embodiment of the present invention;

FIGS. 3a and 3b illustrate operational statuses of the height adjusting section of the apparatus for manufacturing a bent glass sheet in accordance with the embodiment of the present invention, wherein FIG. 3a is a front view illustrating a folded status and FIG. 3b is a front view illustrating an unfolded status;

FIG. 4 is a perspective view illustrating an entire construction of an apparatus for manufacturing a bent glass sheet in accordance with another embodiment of the preset invention;

FIG. 5 is a side of FIG. 4;

FIG. 6 is a front view illustrating a structure of a height adjusting section of the apparatus for manufacturing a bent glass sheet in accordance with another embodiment of the present invention; and

FIG. 7 is a cross-sectional view illustrating a structure of a locking section of the apparatus for manufacturing a bent glass sheet in accordance with another embodiment of the present invention.

### BEST MODE FOR CARRYING OUT THE INVENTION

Reference will now be made in greater detail to a preferred embodiment of the invention, an example of which is illustrated in the accompanying drawings. Wherever possible, the same reference numerals will be used throughout the drawings and the description to refer to the same or like parts.

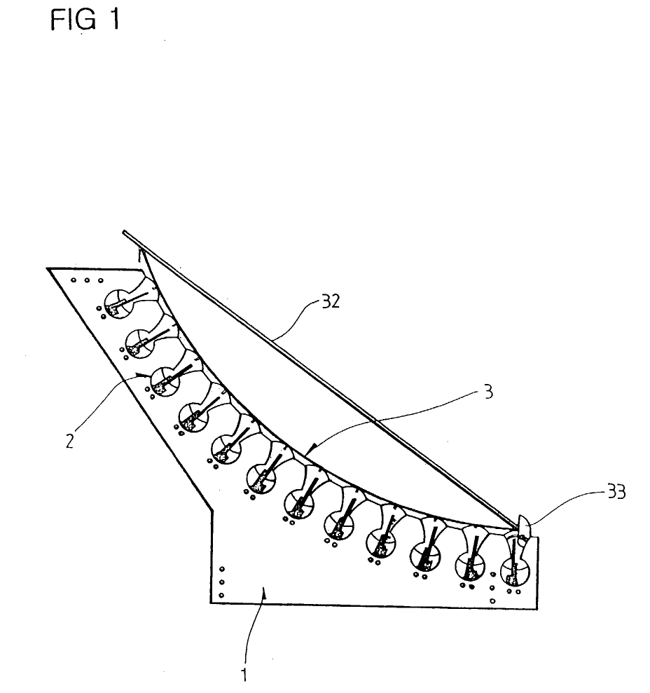

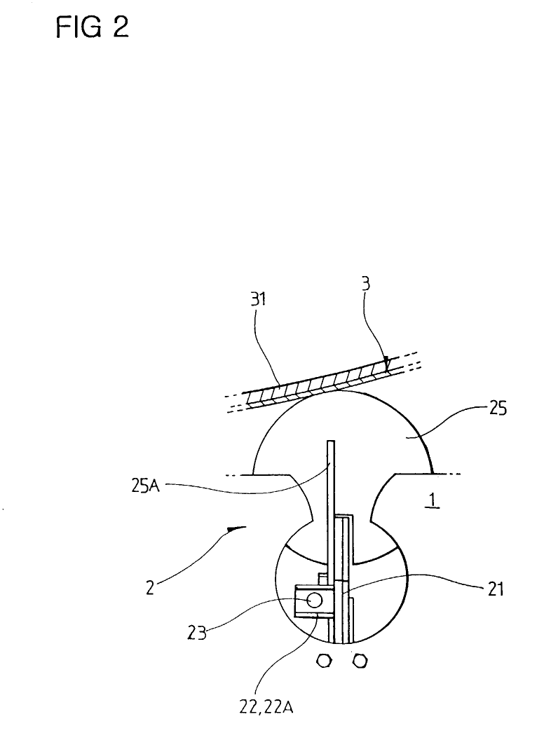

FIG. 1 is a side view illustrating an entire construction of an apparatus for manufacturing a bent glass sheet in accordance with an embodiment of the present invention. The apparatus has a body 1 which defines as a whole a curved outline. A plurality of height adjusting sections 2 are separately configured along a lengthwise direction of the body 1 adjacent to an upper end of the body 1. A forming mold 3 which also defines a curved outline, is placed on the plurality of height adjusting sections 2. The forming mold 3 has a shape of a plate and is made of stainless steel, and a ceramic cloth 31 (see FIG. 2) is laminated on an upper surface of the forming mold 3. Here, the unexplained drawing reference numeral 32 represents a flat glass sheet and 33 a movement preventing projection.

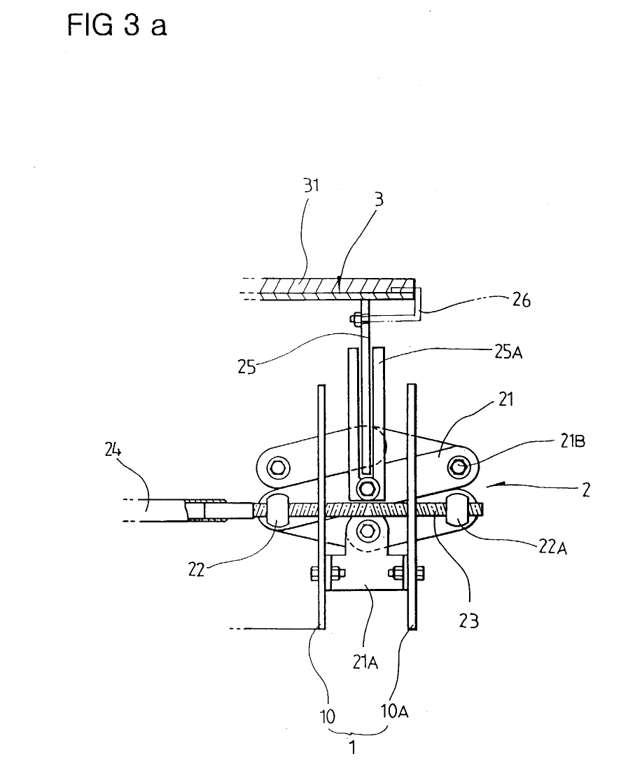

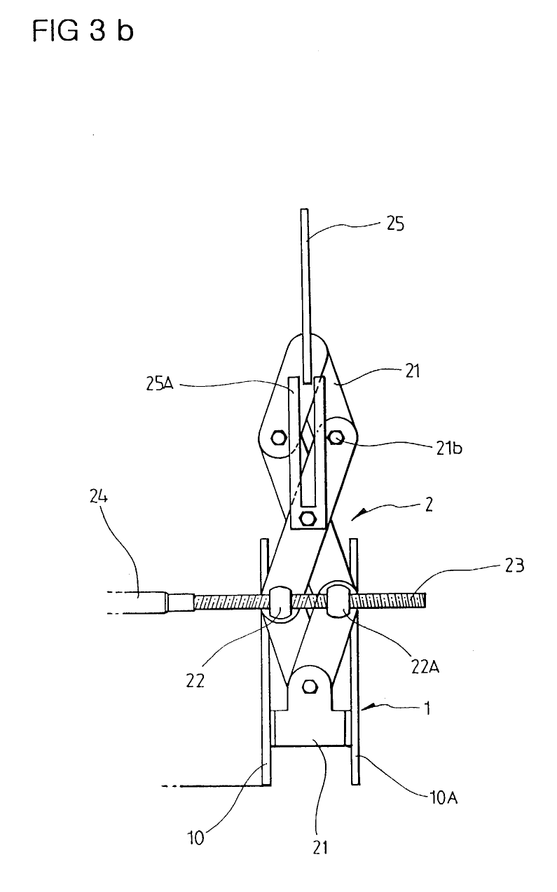

FIG. 2 is a partial enlarged side view illustrating a structure of a height adjusting section of the apparatus for manufacturing a bent glass sheet in accordance with the embodiment of the present invention; and FIGS. 3a and 3b illustrate operational statuses of the height adjusting section of the apparatus for manufacturing a bent glass sheet in accordance with the embodiment of the present invention, wherein FIG. 3a is a front view illustrating a folded status and FIG. 3b is a front view illustrating an unfolded status. As shown in FIGS. 2, 3a and 3b, the body 1 is composed of a pair of frames 10 and 10A which have the same configurations and are arranged at a predetermined separation.

The height adjusting section 2 has a link mechanism 21 which is formed by connecting a plurality of links one with another by means of hinge bolts 21B. A lower end of the link mechanism 21 is fastened to a fastening plate 21A which in turn is affixed to the pair of frames 10 and 10A constituting the body 1. Adjacent to the lower end of the link mechanism 21, the height adjusting section 2 has a first operating nut 22 and a second operating nut 22A which are secured to two hinge bolts 21B for the link mechanism 21 and internally threaded in different directions from each other. A threaded shaft 23 passes through the first and second operating nuts 22 and 22A. The threaded shaft 23 is formed half-and-half with a left-handed screw and a right-handed screw which are threadedly coupled with the first operating nut 22 and the second operating nut 22A, respectively. Therefore, by virtue of normal and reverse rotations of the threaded shaft 23, the link mechanism 21 can be folded and unfolded.

A mold supporting plate 25 is uprightly mounted to an upper end of the link mechanism 21 so that the mold supporting plate 25 is orthogonal to the link mechanism 21. The mold supporting plate 25 functions to support a lower surface of the forming mold 3 which has the upper surface laminated with the ceramic cloth 31. The mold supporting plate 25 is guided by a plate guider 25A. An upper end of the mold supporting plate 25 is fastened to the forming mold 3 by way of a fastening element 26. Here, the unexplained drawing reference numeral 24 represents a connection shaft which is connected to the threaded shaft 23.

Hereinafter, a height adjusting procedure of the apparatus for manufacturing a bent glass sheet according to the present invention, constructed as mentioned above, will be described. First, in a state as shown in FIG. 3a, if the connection shaft 24 connected to the threaded shaft 23 is rotated in one direction, the first and second operating nuts 22 and 22A of the link mechanism 21 which are threadedly coupled with the threaded shaft 23, are moved on the threaded shaft 23 so that a distance therebetween is shortened. By this movement of the first and second operating nuts 22 and 22A, the link mechanism 21 is unfolded as shown in FIG. 3b, whereby the forming mold 3 which is supported by the mold supporting plate 25 uprightly mounted to the upper end of the link mechanism 21, can be raised upward.

In this state, if the connection shaft 24 connected to the threaded shaft 23 is rotated in the other direction, the first and second operating nuts 22 and 22A of the link mechanism 21 which are threadedly coupled with the threaded shaft 23, are moved on the threaded shaft 23 so that a distance therebetween is lengthened. By this movement of the first and second operating nuts 22 and 22A, the link mechanism 21 is folded as shown in FIG. 3a, whereby the forming mold 3 which is supported by the mold supporting plate 25 uprightly mounted to the upper end of the link mechanism 21, can be lowered downward.

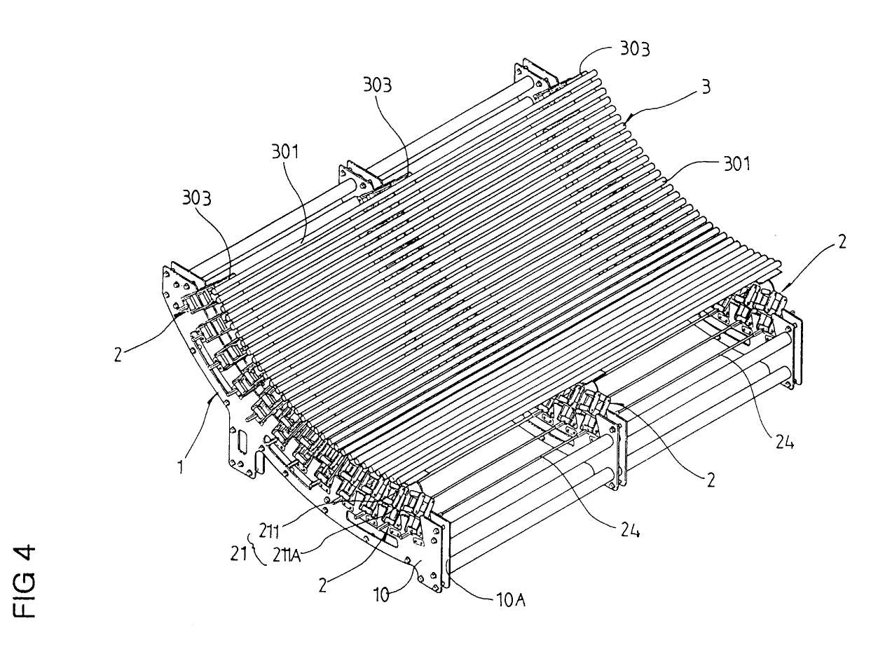

FIG. 4 is a perspective view illustrating an entire construction of an apparatus for manufacturing a bent glass sheet in accordance with another embodiment of the preset invention. The apparatus has a body 1 which defines as a whole a curved outline as in the case of the aforementioned first embodiment of the present invention. The body 1 is composed of three pairs of frames 10 and 10A which three pairs are separately disposed in such a way as to respectively define both side portions and a middle portion of the body 1 and are connected one with another. A plurality of height adjusting sections 2 are placed on the three pairs of frames 10 and 10A along a lengthwise direction of the body 1 in a state wherein they are spaced apart one from another. The height adjusting sections 2 are configured so that they can be operated in an interlocked manner by connection shafts 24. A forming mold 3 which serves as a mold for forming a flat glass sheet into a bent glass sheet, is placed on the plurality of height adjusting sections 2. Each height adjusting section 2 has a link mechanism 21. The link mechanism 21 is structured in a manner such that, by virtue of normal and reverse rotations of the threaded shafts 23 connected between the connection shafts 24, the link mechanism 21 can be folded and unfolded.

The forming mold 3 comprises a plurality of transverse rods 301. The plurality of transverse rods 301 are fastened to and connected one with another by the medium of connection plates 303 which are positioned below them. Due to the fact that the forming mold 3 comprises the plurality of transverse rods 301, deformation such as distortion which otherwise may be induced due to thermal expansion in the case of the plate-shaped forming mold made of stainless steel as described in the aforementioned first embodiment of the present invention, is avoided, and it is possible to prevent a bent glass sheet from being cracked due to deformation.

Each of the transverse rods 301 is formed to have a length which corresponds to a width of the body 1. The plurality of transverse rods 301 are spaced apart one from another by a predetermined interval along the lengthwise direction of the body 1. As described above, the plurality of transverse rods 301 are fastened to and connected one with another by the medium of three connection plates 303 which are positioned below both ends and a middle portion of the transverse rod 301 and which are disposed over the three pairs of frames 10 and 10A, respectively.

The link mechanism 21 which constitutes the height adjusting section 2, comprises front and rear link mechanism parts 211 and 211A, whereby more stable support of a bent glass sheet can be effectuated.

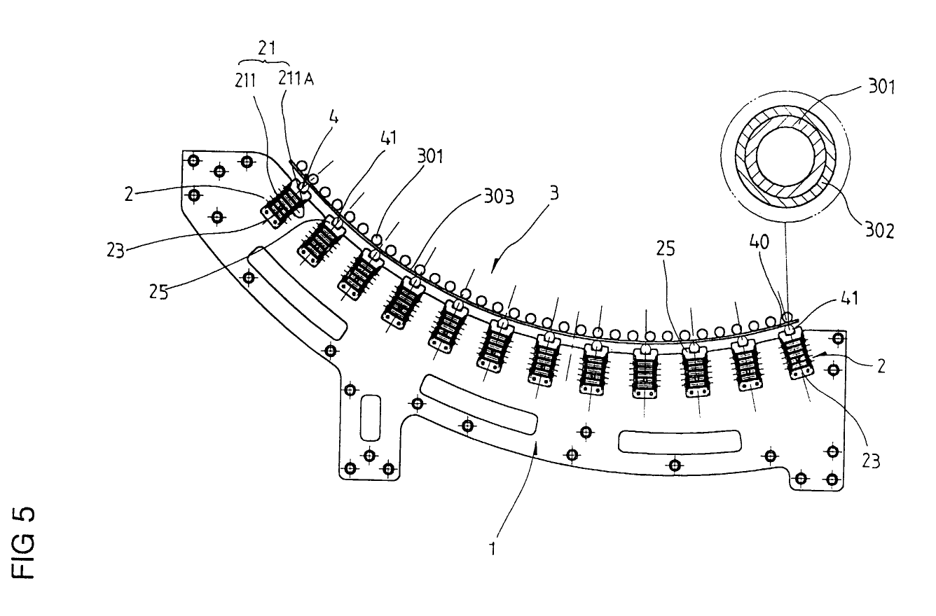

FIG. 5 is a side of FIG. 4. As can be readily seen from FIG. 5, in the present embodiment, the plurality of height adjusting sections 2 are placed on an upper surface of the body 1 in a state wherein they are spaced apart one from another. The forming mold 3 which comprises the plurality of transverse rods 301, is placed on the plurality of height adjusting sections 2. The transverse rods 301 are fastened to and connected one with another by the medium of the connection plates 303 which are positioned below them. A plurality of rolling sections 4 are provided between the forming mold 3 and the height adjusting sections 2, respectively, which are located below the connection plates 303. The rolling section 4 enables the forming mold 3 to be rolled in forward and rearward directions. Each rolling section 4 has a roller 41. The link mechanism 21 which constitutes the height adjusting section 2, has the front and rear link mechanism parts 211 and 211A. The front and rear link mechanism parts 211 and 211A are structured in a manner such that, by virtue of normal and reverse rotations of the threaded shafts 23 connected between the connection shafts 24, they can be folded and unfolded. A ceramic cloth 302 is laminated on a circumferential outer surface of the transverse rod 301 which constitutes the forming mold 3.

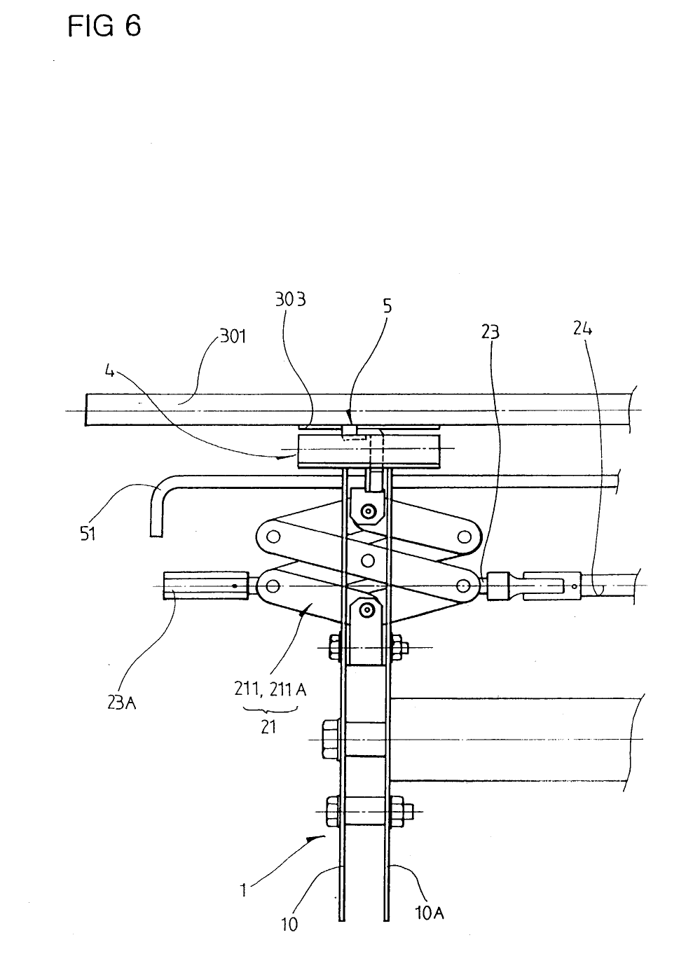

FIG. 6 is a front view illustrating a structure of a height adjusting section of the apparatus for manufacturing a bent glass sheet in accordance with another embodiment of the present invention. As shown in FIG. 6, in the present invention, the body 1 is composed of the three pairs of frames 10 and 10A on which the link mechanisms 21 of the height adjusting sections 2 are placed. A lower end of each of the link mechanism parts 211 and 211A is fastened to a fastening plate 21A which in turn is affixed to the pair of frames 10 and 10A constituting the body 1. A mold supporting plate 25 which functions to support the forming mold 3, is uprightly mounted to an upper end of each of the link mechanism parts 211 and 211A.

As described above, each of the link mechanism parts 211 and 211A is coupled with the threaded shaft 23 so that, by virtue of normal and reverse rotations of the threaded shaft 23 connected between the connection shafts 24, it can be folded and unfolded. A handle 23A is formed at an end of the threaded shaft 23.

The plurality of rolling sections 4 each of which has the roller 41, are disposed below the connection plates 303 of the forming mold 3. By the presence of the rolling sections 4, the forming mold 3 can be rolled in forward and rearward directions of the body 1. The roller 41 is supported by a roller supporting member 42. The roller supporting member 42 is assembled to a middle portion of the mold supporting plate 25 of the link mechanism part 211 or 211A so as to be operated in an interlocked manner with the mold supporting plate 25. As means for controlling a rolling operation of the forming mold 3 by the rolling sections 4, a plurality of locking sections 5 are provided between the height adjusting sections 2 and the forming mold 3.

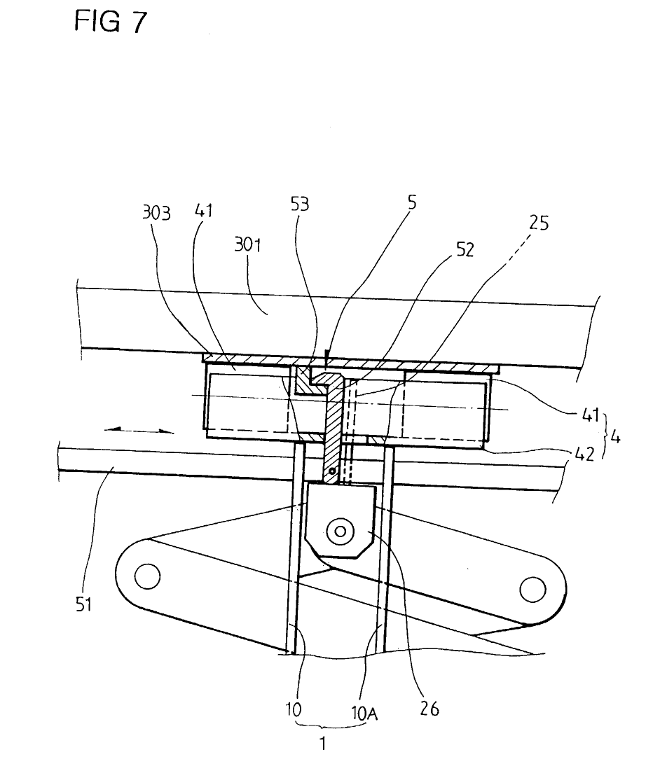

FIG. 7 is a cross-sectional view illustrating a structure of a locking section of the apparatus for manufacturing a bent glass sheet in accordance with another embodiment of the present invention. As shown in FIG. 7, in order to constitute each locking section 5, an engaging projection 53 is projectedly formed on a lower surface of the connection plate 303 to which the transverse rods 301 are secured, a locking rod 51 is located below the rolling section 4 so as to be reciprocatingly moved along a straight line by being pushed and pulled, and a hook 52 integrally projects upward from the locking rod 51.

That is to say, if the hook 52 of the locking rod 51 is disengaged from the engaging projection 53, the connection plates 303 including the transverse rods 301 are rolled on the rollers 41 of the rolling sections 4 in the forward and rearward directions of the body 1. On the contrary, by pulling the locking rod 51, if the hook 52 of the locking rod 51 is engaged with the engaging projection 53, a locked state is accomplished, wherein the connection plates 303 including the transverse rods 301 are prevented from being rolled. At this time, because the engaging projection 53 is formed to have a curved outline in the same manner as the connection plate 303, only by engagement between the engaging projection 53 and the hook 52, the connection plate 303 can be prevented from being rolled.

Industrial Applicability

As a result, the apparatus for manufacturing a bent glass sheet according to the present invention provides advantages in that, since a plurality of height adjusting sections each of which has a link mechanism, are separately configured at both sides of a body along a lengthwise direction and the link mechanism is folded and unfolded by virtue of normal and reverse rotations of a threaded shaft, when manufacturing bent glass sheets having a variety of contours, other than the conventional art in which forming molds of different curvatures must be individually fabricated to correspond to the contours, a bent glass sheet of a desired curvature can be conveniently formed only with rotation of threaded shafts.

Also, due to the fact that a ceramic cloth is laminated to an upper surface of a forming mold, when manufacturing a bent glass sheet, a mark or an air bubble is not created, whereby a fraction defective is remarkably decreased and quality of an end product can be enhanced.

Moreover, as in another embodiment of the present invention, because a forming mold is composed of a plurality of rods, deformation such as distortion which otherwise can be induced in a plate-shaped forming mold, is avoided, and it is possible to prevent the bent glass sheet from being cracked due to deformation.

Furthermore, as in another embodiment of the present invention, due to the fact that the forming mold can be rolled in forward and rearward directions of the body or can be locked to be stationarily maintained, the bent glass sheet can be removed from the forming mold in an easy manner, whereby efficiency and convenience upon performing a bent glass sheet forming work are elevated.

In the drawings and specification, there have been disclosed typical preferred embodiments of the invention and, although specific terms are employed, they are used in a generic and descriptive sense only and not for purposes of limitation, the scope of the invention being set forth in the following claims.

1. An apparatus for manufacturing a bent glass sheet, comprising:
a plurality of height adjusting sections which are separately configured at both sides of a body of the apparatus along a lengthwise direction of the body adjacent to an upper end of the body and each of which has a link mechanism, the link mechanism being connected with a threaded shaft which extends in a widthwise direction of the body, so as to be folded and unfolded by virtue of normal and reverse rotations of the threaded shaft; and
a forming mold positioned at the upper end of the body so that the forming mold is supported by the plurality of height adjusting sections, the forming mold extending over an entire length of the body.

2. The apparatus as claimed in claim 1, wherein each height adjusting section has a first operating nut and a second operating nut which are secured to two hinge bolts for the link mechanism and internally threaded in different directions from each other; and the threaded shaft which passes through the first and second operating nuts, is formed with a left-handed screw and a right-handed screw which are threadedly coupled with the first operating nut and the second operating nut, respectively.

3. The apparatus as claimed in claim 1, wherein each link mechanism is composed of a pair of front and rear link mechanism parts, and a pair of mold supporting plates are uprightly mounted to upper ends of the pair of link mechanism parts so that the mold supporting plates are orthogonal to the link mechanism parts, respectively.

4. The apparatus as claimed in claim 1, wherein the forming mold has a shape of a plate which is made of stainless steel and on an upper surface of which a ceramic cloth is laminated.

5. The apparatus as claimed in claim 1, wherein the forming mold comprises a plurality of transverse rods each of which is laminated on a circumferential outer surface thereof with a ceramic cloth, and both ends of each transverse rod are respectively secured to connection plates which extend in the lengthwise direction of the body so that the transverse rods are supported by the height adjusting sections by the medium of the connection plates.

6. The apparatus as claimed in claims 1 or 5, wherein a rolling section which has a freely rotatable roller, is provided to the height adjusting section which is located below the connection plate of the forming mold; and wherein a locking section is configured by the fact that a locking shaft is placed between the rolling section and the link mechanism in such a way as to be pushed and pulled thereby to be moved in the widthwise direction of the body, a hook is integrally formed with the locking shaft to extend in an upward direction, and an engaging projection which is to be engaged with the hook, is formed on a lower surface of the connection plate.
